(19) United States
(12) Patent Application Publication
(10) Pub. No.: US 2006/0234046 A1
(43) Pub. Date: Oct. 19, 2006

(54) Magnetic adhesive tape and a method for manufacturing the magnetic adhesive tape

(76) Inventor: Hung-Chih Wu, Taipei (TW)

Correspondence Address: BRUCE H. TROXELL, SUITE 1404, 5205 LEESBURG PIKE, FALLS CHURCH, VA, 22041, US

(21) Appl. No.: 11/106,585

(22) Filed: Apr. 15, 2005

(51) Int. Cl. B05D 5/10; B32B 7/12; C08J 7/04

(52) U.S. Cl. 428/352; 428/343; 427/505; 427/208

(57) ABSTRACT

A magnetic adhesive tape and a method for manufacturing the magnetic adhesive tape. A high-effect releasing agent and a property-changing agent are added into a soft magnetic material and blended with each other to form a strip-like soft magnetic substrate with releasable surface. One face of the substrate is purified or roughened and coated with a high-effect adhesive layer. The substrate is wound on a reel. An outer end of the wound substrate can be drawn out segment by segment for use.

### BACKGROUND OF THE INVENTION

The present invention is related to a magnetic adhesive tape and a method for manufacturing the magnetic adhesive tape, and more particularly to a magnetic adhesive tape having both adhesion and magnetic attraction.

A conventional adhesive tape is widely used in daily life. One face of a conventional adhesive tape is coated with an adhesive. The tape is wound on a reel. In use, an outer end of the tape is drawn out and cut into a segment for attaching to an article.

The tape body of the conventional single-face adhesive tape is mainly made of soft plastic material such as PVC or EVA. An adhesive layer is coated on one face of the tape body. The tape body is wound on a reel.

The above conventional adhesive tape can be improved or modified as necessary. For example, a thin soft magnetic strap can be used as a substrate. A releasing agent and an adhesive can be respectively coated on two faces of the substrate. Such adhesive tape has both adhesion and magnetic attraction. Taiwanese Patent Application No. 93202971 discloses a magnetic adhesive tape. An adhesive layer is coated on one face of a magnetic substrate. A releasing agent is coated on the other face of the magnetic substrate. When wound, the releasing agent prevents the adhesive layer from adhering to the other face. Therefore, when used, the adhesive tape can be unwound.

### SUMMARY OF THE INVENTION

It is a primary object of the present invention to provide a magnetic adhesive tape and a method for manufacturing the magnetic adhesive tape. A high-effect releasing agent and a property-changing agent are directly added into a soft magnetic material and blended with each other to form a tape the entire surface of which has even releasing effect. One face of the tape is purified or roughened and coated with a high-effect adhesive layer. The adhesive layer is not easy to peel off from the surface of the tape so that the adhesion of the tape is enhanced. In addition, when manufacturing the above magnetic adhesive tape, it is unnecessary to coat the tape with any releasing agent. Therefore, the manufacturing procedure is simplified.

It is a further object of the present invention to provide the above magnetic adhesive tape and the method for manufacturing the magnetic adhesive tape. When making the tape, the surface of the tape is at the same time embossed with an embosser to form dense stripes. By means of the stripes of the embossed surface, the tape can be manually torn off without using any knife to facilitate the use of the tape.

According to the above objects, the magnetic adhesive tape of the present invention is made in such a manner that a high-effect releasing agent and a property-changing agent are added into a soft magnetic material and blended with each other to form a strip-like soft magnetic substrate with releasable surface. One face of the substrate is purified or roughened and coated with a high-effect adhesive layer. The substrate is wound on a reel. An outer end of the wound substrate can be drawn out segment by segment for use. Accordingly, one face of the substrate is coated with the adhesive layer for adhering to a back face of an article. The other face of the substrate has magnetic attraction for attracting and attaching to a wall face or board face.

The present invention can be best understood through the following description and accompanying drawings wherein:

### BRIEF DESCRIPTION OF THE DRAWINGS

FIG. 1 is a manufacturing flow chart of the present invention;

FIG. 2 is a perspective view of a product of the present invention; and

FIG. 3 is a perspective view of another product of the present invention.

### DETAILED DESCRIPTION OF THE PREFERRED EMBODIMENTS

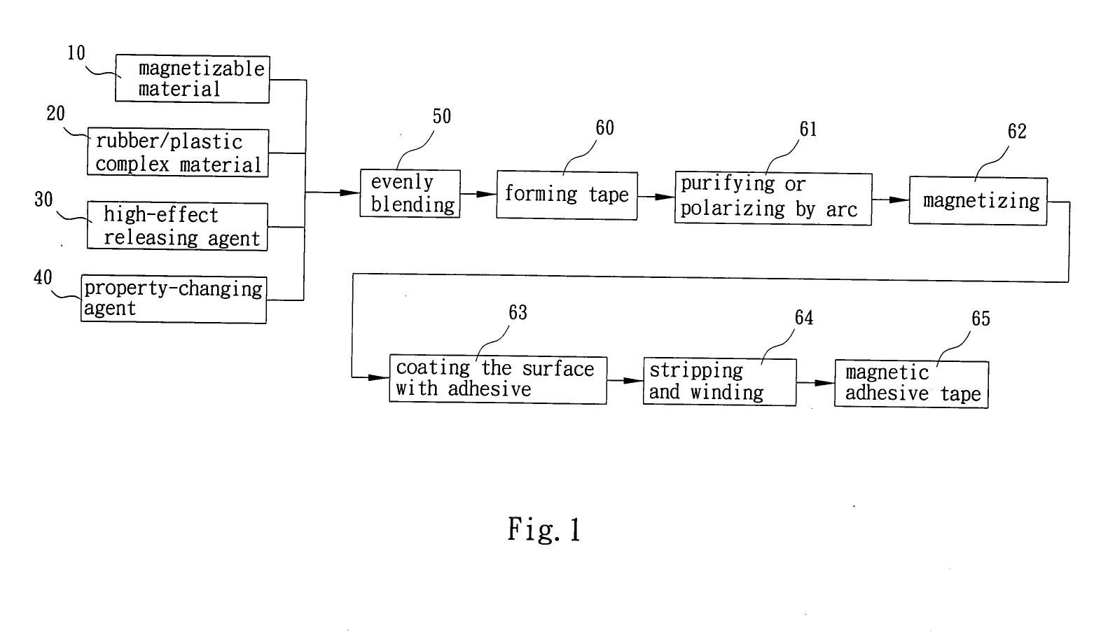

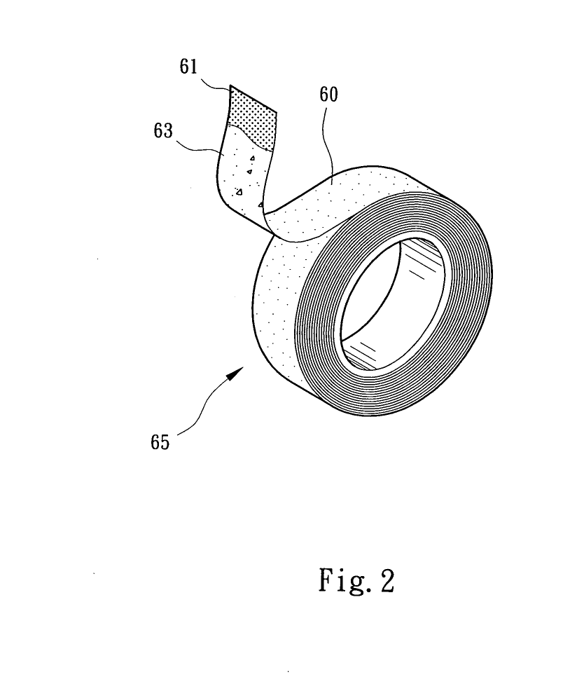

Please refer to FIGS. 1 and 2. The magnetic adhesive tape of the present invention is made from a mixture of a magnetizable material 10 (such as barium, strontium, rubidium, cobalt, boron or ferric oxide powder), rubber/plastic complex material 20, high-effect releasing agent 30 (such as saturated fatty acid ester derivative) and property-changing agent 40 (such as mixture of emulsified calcium soap and fatty acid). The above materials are evenly blended 50 and then made into thin tape 60. Then, at least one face of the tape 60 is wiped by rollers or chemically purified (roughened) or polarized by arc 61. Then the tape 60 is magnetized 62. Then the purified face is coated with an adhesive 63. Then the tape 60 is stripped and wound 64 to form a magnetic adhesive tape 65.

In manufacturing, the high-effect releasing agent 30 is added into the tape 60. Therefore, the surface of the entire tape 60 itself has high releasing capability. Accordingly, the adhesive can hardly adhere to the surface. (After surface treatment, the adhesion can be enhanced.) Therefore, after wound, the surface free from the adhesive can be easily released from the surface with the adhesive coating.

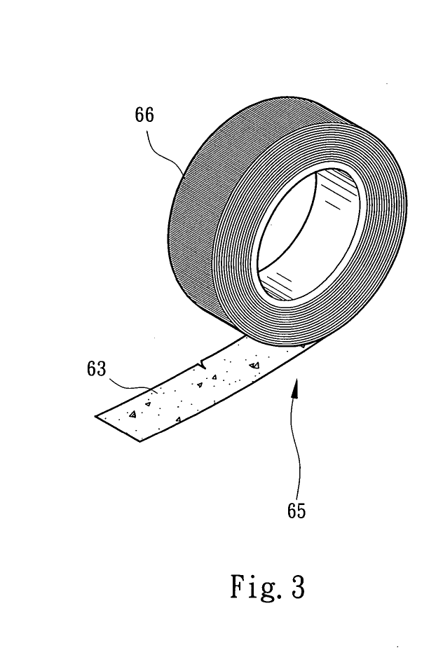

Moreover, in the case that in the forming procedure, the surface of the tape 60 free from the adhesive is densely embossed with an embosser to form stripes 66 (as shown in FIG. 3), the tape 60 can be manually torn off without using any knife. This facilitates the use of the tape. In addition, the stripes 66 of the embossed surface of the tape can reduce the contact area between the surface and the adhesive coating 63 so as to enhance the releasability.

In conclusion, when manufacturing the above magnetic adhesive tape, it is unnecessary to coat the tape with any releasing agent. Therefore, the manufacturing time is shortened and the cost is reduced. Moreover, the entire tape has an even and reliable releasing effect. After surface treatment, the tape is coated with the adhesive so as to firmly bond the adhesive with the tape. By means of the stripes of the embossed surface, the tape can be manually torn off without using any knife to facilitate the use of the tape.

The above embodiments are only used to illustrate the present invention, not intended to limit the scope thereof. Many modifications of the above embodiments can be made without departing from the spirit of the present invention.

What is claimed is:

1. A magnetic adhesive tape comprising an elongated magnetic tape to which a high-effect releasing agent is added, whereby the entire surface of the tape has high releasing capability, one face of the tape being surface-treated and then coated with an adhesive layer.

2. The magnetic adhesive tape as claimed in claim 1, wherein the face of the tape is such surface-treated that the face is wiped and purified.

3. The magnetic adhesive tape as claimed in claim 1, wherein the face of the tape is such surface-treated that the face is polarized by arc.

4. The magnetic adhesive tape as claimed in claim 1, wherein the surface of the tape is embossed with dense stripes.

5. The magnetic adhesive tape as claimed in claim 2, wherein the surface of the tape is embossed with dense stripes.

6. The magnetic adhesive tape as claimed in claim 3, wherein the surface of the tape is embossed with dense stripes.

7. A method for manufacturing magnetic adhesive tape, comprising steps of:
mixing a magnetizable material, a rubber/plastic complex material, a high-effect releasing agent and a property-changing agent with each other and evenly blending the mixture;
making a thin tape from the mixture;
surface-treating at least one face of the tape;
magnetizing the tape; and
coating the treated face with an adhesive.

8. The method for manufacturing magnetic adhesive tape as claimed in claim 7, wherein the face of the tape is such surface-treated that the face is wiped and purified.

9. The method for manufacturing magnetic adhesive tape as claimed in claim 7, wherein the face of the tape is such surface-treated that the face is polarized by arc.

10. The method for manufacturing magnetic adhesive tape as claimed in claim 7, wherein the high-effect releasing agent is a saturated fatty acid ester derivative.

11. The method for manufacturing magnetic adhesive tape as claimed in claim 8, wherein the high-effect releasing agent is a saturated fatty acid ester derivative.

12. The method for manufacturing magnetic adhesive tape as claimed in claim 9, wherein the high-effect releasing agent is a saturated fatty acid ester derivative.

13. The method for manufacturing magnetic adhesive tape as claimed in claim 7, wherein the property-changing agent is a mixture of emulsified calcium soap and fatty acid.

14. The method for manufacturing magnetic adhesive tape as claimed in claim 8, wherein the property-changing agent is a mixture of emulsified calcium soap and fatty acid.

15. The method for manufacturing magnetic adhesive tape as claimed in claim 9, wherein the property-changing agent is a mixture of emulsified calcium soap and fatty acid.

16. The method for manufacturing magnetic adhesive tape as claimed in claim 7, wherein when making the thin tape, the surface of the tape is at the same time embossed with an embosser to form stripes.

17. The method for manufacturing magnetic adhesive tape as claimed in claim 8, wherein when making the thin tape, the surface of the tape is at the same time embossed with an embosser to form stripes.

18. The method for manufacturing magnetic adhesive tape as claimed in claim 9, wherein when making the thin tape, the surface of the tape is at the same time embossed with an embosser to form stripes.

19. The method for manufacturing magnetic adhesive tape as claimed in claim 10, wherein when making the thin tape, the surface of the tape is at the same time embossed with an embosser to form stripes.

20. The method for manufacturing magnetic adhesive tape as claimed in claim 11, wherein when making the thin tape, the surface of the tape is at the same time embossed with an embosser to form stripes.

21. The method for manufacturing magnetic adhesive tape as claimed in claim 12, wherein when making the thin tape, the surface of the tape is at the same time embossed with an embosser to form stripes.

22. The method for manufacturing magnetic adhesive tape as claimed in claim 13, wherein when making the thin tape, the surface of the tape is at the same time embossed with an embosser to form stripes.

23. The method for manufacturing magnetic adhesive tape as claimed in claim 14, wherein when making the thin tape, the surface of the tape is at the same time embossed with an embosser to form stripes.

24. The method for manufacturing magnetic adhesive tape as claimed in claim 15, wherein when making the thin tape, the surface of the tape is at the same time embossed with an embosser to form stripes.
